(19) United States
(12) Patent Application Publication
(10) Pub. No.: US 2023/0325593 A1
(43) Pub. Date: Oct. 12, 2023

(54) COMPUTING DEVICE AND METHODS PROVIDING ENHANCED LANGUAGE DETECTION AND DISPLAY FEATURES FOR VIRTUAL COMPUTING SESSIONS

(71) Applicant: CITRIX SYSTEMS, INC., FORT LAUDERDALE, FL (US)

(72) Inventors: TIANZE JIANG, NANJING (CN); YU XIN, NANJING (CN)

(21) Appl. No.: 17/663,266

(22) Filed: May 13, 2022

Related U.S. Application Data
(63) Continuation of application No. PCT/CN2022/085449, filed on Apr. 7, 2022.

(51) Int. Cl. G06F 40/263; G06F 40/47; G06F 40/51; G06F 40/58

(52) U.S. Cl. CPC G06F 40/263; G06F 40/47; G06F 40/51; G06F 40/58

(57) ABSTRACT

A computing device may include a memory and a processor coupled to the memory and configured to run a browser to access a virtual computing session. The browser may have a first language associated therewith, and the virtual computing session may be provided in the first language responsive to the browser. The processor may be further configured to capture text input to the browser for the virtual computing session, determine whether the captured text corresponds to a second language different than the first language, and cause the virtual computing session to be provided in the second language responsive to determining the captured text corresponds to the second language.

### RELATED APPLICATIONS

This application is a continuation of PCT application serial no. PCT/CN2022/085449 filed Apr. 7, 2022, which is hereby incorporated herein in its entirety by reference.

### BACKGROUND

Web applications or apps are software programs that run on a server and are accessed remotely by client devices through a Web browser. That is, while Web applications have a similar functionality to native applications installed directly on the client device, Web applications are instead installed and run on the server, and only the browser application is installed on the client device. Although in some implementations, a hosted browser running on a virtualization server may be used to access Web applications as well.

One advantage of using Web applications is that this allows client devices to run numerous different applications without having to install all of these applications on the client device. This may be particularly beneficial for thin client devices, which typically have reduced memory and processing capabilities. Moreover, updating Web applications may be easier than native applications, as updating is done at the server level rather than having to push out updates to numerous different types of client devices.

Software as a Service (SaaS) is a Web application licensing and delivery model in which applications are delivered remotely as a web-based service, typically on a subscription basis. SaaS is used for delivering several different types of business (and other) applications, including office, database, accounting, customer relation management (CRM), etc.

### SUMMARY

A computing device may include a memory and a processor coupled to the memory and configured to run a browser to access a virtual computing session. The browser may have a first language associated therewith, and the virtual computing session may be provided in the first language responsive to the browser. The processor may be further configured to capture text input to the browser for the virtual computing session, determine whether the captured text corresponds to a second language different than the first language, and cause the virtual computing session to be provided in the second language responsive to determining the captured text corresponds to the second language.

In an example embodiment, the processor may be further configured to determine if the second language is on a supported language list for the virtual computing session, and to cause the virtual computing session to be provided in the second language further based upon determining the second language is on the supported language list. In accordance with another example, the processor may be further configured to cause the browser to display an input element responsive to determining the captured text corresponds to the second language, and to cause the virtual computing session to be provided in the second language further based upon input received via the input element.

In some implementations, the browser may have an Application Programming Interface (API) associated therewith, and the processor may be configured to capture the text input via the API, for example. In accordance with another example implementation, the processor may be further configured to run an Input Method Editor (IME), and to capture the text input to the browser from the IME.

By way of example, the virtual computing session may comprise at least one of a Web application and a Software as a Service (SaaS) application. In one example implementation, the processor may be further configured to communicate the captured text to a language detection server, and to determine whether the captured text corresponds to the second language responsive to the language detection server.

A related method may include running a browser at a computing device to access a virtual computing session, with the browser having a first language associated therewith, and the virtual computing session being provided in the first language responsive to the browser. The method may also include capturing text input to the browser at the computing device for the virtual computing session, determining, at the computing device, whether the captured text corresponds to a second language different than the first language, and causing the virtual computing session to be provided in the second language at the computing device responsive to determining the captured text corresponds to the second language.

A related non-transitory computer-readable medium may have computer-executable instructions for causing a computing device to perform steps including running a browser to access a virtual computing session, with the browser having a first language associated therewith, and the virtual computing session being provided in the first language responsive to the browser. The steps may further include capturing text input to the browser for the virtual computing session, determining whether the captured text corresponds to a second language different than the first language, and causing the virtual computing session to be provided in the second language responsive to determining the captured text corresponds to the second language.

### BRIEF DESCRIPTION OF THE DRAWINGS

FIG. 1 is a schematic block diagram of a network environment of computing devices in which various aspects of the disclosure may be implemented.

FIG. 2 is a schematic block diagram of a computing device useful for practicing an embodiment of the client machines or the remote machines illustrated in FIG. 1.

FIG. 3 is a schematic block diagram of a cloud computing environment in which various aspects of the disclosure may be implemented.

FIG. 4 is a schematic block diagram of desktop, mobile and web-based devices operating a workspace app in which various aspects of the disclosure may be implemented.

FIG. 5 is a schematic block diagram of a workspace network environment of computing devices in which various aspects of the disclosure may be implemented.

FIG. 6 is a schematic block diagram of a computing device providing enhanced language detection and display features in accordance with an example embodiment.

FIG. 7 is a schematic block diagram illustrating an example implementation of the computing device of FIG. 6.

FIGS. 8 and 9A-9B are flow diagram illustrating example method aspects associated with FIGS. 6 and 7.

### DETAILED DESCRIPTION

Globalization is important for a software product to provide services for customers around the world. In this regard, it is advantageous to set the display language for a software User Interface (UI) according to the user's convention when an app is installed or launched (startup). However, for Web/Software as a Service (SaaS) apps which run on remote servers and are accessed through browsers, the display language is sometimes not as expected for various reasons. For example, the browser language may follow the system locale during installation by default, which is then adopted by Web/SaaS apps even though this is not the language preferred by the user. While browsers may provide language settings for users to switch between different languages, this may not be easy or intuitive for all users. Furthermore, browsers typically cannot read current system locale/keyboard information due to limitations of internal Application Programming Interfaces (APIs), whereas the current system locale/keyboard layout is more likely to be set to a user's preference. Another reason is that, for users working on shared computers or kiosks, these types of computers may record the preferences of the last user.

The approach set forth herein overcomes these technical challenges by capturing text input to the browser running a Web/SaaS app in virtual computing session, and determining whether the captured text corresponds to a second language different than a first (e.g., default) language of the browser. As a result, the Web/SaaS app may instead automatically be provided in the second language preferred by the user. That is, this approach allows for dynamic changing of languages displayed by Web/SaaS apps based upon detecting user keyboard/IME input via the browser running the Web/SaaS app.

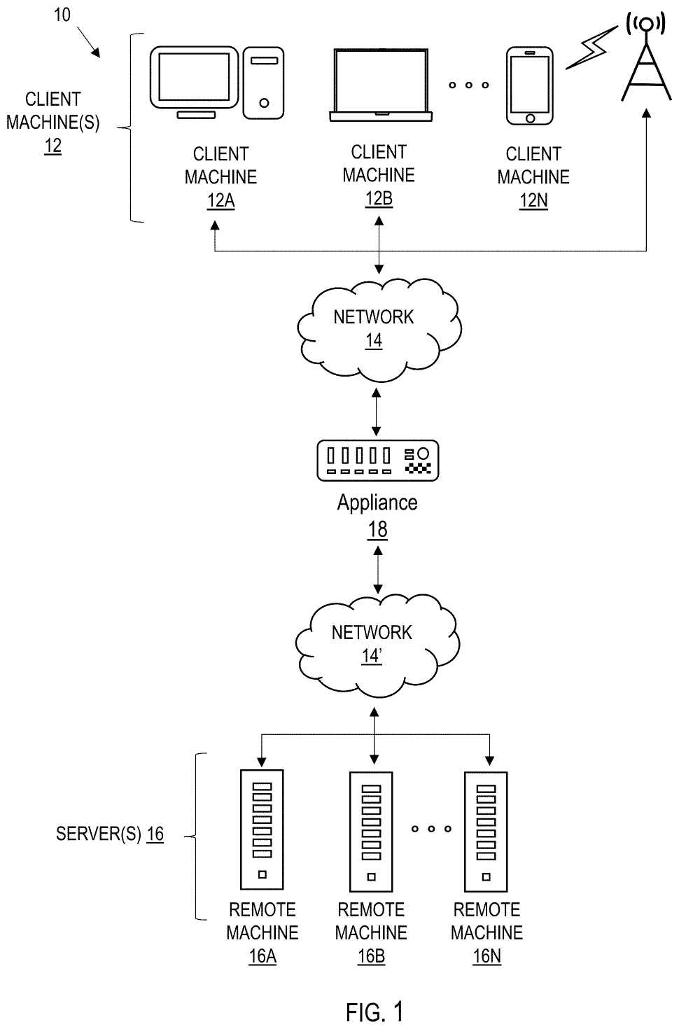

Referring initially to FIG. 1, a non-limiting network environment 10 in which various aspects of the disclosure may be implemented includes one or more client machines 12A-12N, one or more remote machines 16A-16N, one or more networks 14, 14′, and one or more appliances 18 installed within the computing environment 10. The client machines 12A-12N communicate with the remote machines 16A-16N via the networks 14, 14′.

In some embodiments, the client machines 12A-12N communicate with the remote machines 16A-16N via an intermediary appliance 18. The illustrated appliance 18 is positioned between the networks 14, 14′ and may also be referred to as a network interface or gateway. In some embodiments, the appliance 108 may operate as an application delivery controller (ADC) to provide clients with access to business applications and other data deployed in a data center, the cloud, or delivered as Software as a Service (SaaS) across a range of client devices, and/or provide other functionality such as load balancing, etc. In some embodiments, multiple appliances 18 may be used, and the appliance(s) 18 may be deployed as part of the network 14 and/or 14′.

The client machines 12A-12N may be generally referred to as client machines 12, local machines 12, clients 12, client nodes 12, client computers 12, client devices 12, computing devices 12, endpoints 12, or endpoint nodes 12. The remote machines 16A-16N may be generally referred to as servers 16 or a server farm 16. In some embodiments, a client device 12 may have the capacity to function as both a client node seeking access to resources provided by a server 16 and as a server 16 providing access to hosted resources for other client devices 12A-12N. The networks 14, 14′ may be generally referred to as a network 14. The networks 14 may be configured in any combination of wired and wireless networks.

A server 16 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 16 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 16 may execute a remote presentation services program or other program that uses a thin-client or a remote-display protocol to capture display output generated by an application executing on a server 16 and transmit the application display output to a client device 12.

In yet other embodiments, a server 16 may execute a virtual machine providing, to a user of a client device 12, access to a computing environment. The client device 12 may be a virtual machine. The virtual machine may be managed by, for example, a hypervisor, a virtual machine manager (VMM), or any other hardware virtualization technique within the server 16.

In some embodiments, the network 14 may be: a local-area network (LAN); a metropolitan area network (MAN); a wide area network (WAN); a primary public network 14; and a primary private network 14. Additional embodiments may include a network 14 of mobile telephone networks that use various protocols to communicate among mobile devices. For short range communications within a wireless local-area network (WLAN), the protocols may include 802.11, Bluetooth, and Near Field Communication (NFC).

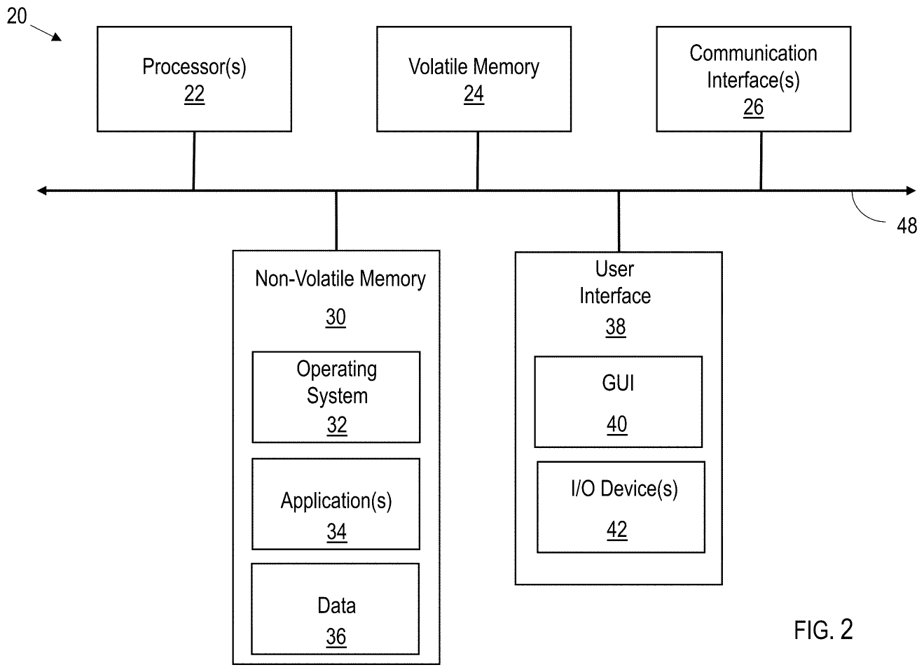

FIG. 2 depicts a block diagram of a computing device 20 useful for practicing an embodiment of client devices 12, appliances 18 and/or servers 16. The computing device 20 includes one or more processors 22, volatile memory 24 (e.g., random access memory (RAM)), non-volatile memory 30, user interface (UI) 38, one or more communications interfaces 26, and a communications bus 48.

The non-volatile memory 30 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 38 may include a graphical user interface (GUI) 40 (e.g., a touchscreen, a display, etc.) and one or more input/output (I/O) devices 42 (e.g., a mouse, a keyboard, a microphone, one or more speakers, one or more cameras, one or more biometric scanners, one or more environmental sensors, and one or more accelerometers, etc.).

The non-volatile memory 30 stores an operating system 32, one or more applications 34, and data 36 such that, for example, computer instructions of the operating system 32 and/or the applications 34 are executed by processor(s) 22 out of the volatile memory 24. In some embodiments, the volatile memory 24 may include one or more types of RAM and/or a cache memory that may offer a faster response time than a main memory. Data may be entered using an input device of the GUI 40 or received from the I/O device(s) 42. Various elements of the computer 20 may communicate via the communications bus 48.

The illustrated computing device 20 is shown merely as an example client device or server, and may be implemented by any computing or processing environment with any type of machine or set of machines that may have suitable hardware and/or software capable of operating as described herein.

The processor(s) 22 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

The processor 22 may be analog, digital or mixed-signal. In some embodiments, the processor 22 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

The communications interfaces 26 may include one or more interfaces to enable the computing device 20 to access a computer network such as a Local Area Network (LAN), a Wide Area Network (WAN), a Personal Area Network (PAN), or the Internet through a variety of wired and/or wireless connections, including cellular connections.

In described embodiments, the computing device 20 may execute an application on behalf of a user of a client device. For example, the computing device 20 may execute one or more virtual machines managed by a hypervisor. Each virtual machine may provide an execution session within which applications execute on behalf of a user or a client device, such as a hosted desktop session. The computing device 20 may also execute a terminal services session to provide a hosted desktop environment. The computing device 20 may provide access to a remote computing environment including one or more applications, one or more desktop applications, and one or more desktop sessions in which one or more applications may execute.

An example virtualization server 16 may be implemented using Citrix Hypervisor provided by Citrix Systems, Inc., of Fort Lauderdale, Florida (“Citrix Systems”). Virtual app and desktop sessions may further be provided by Citrix Virtual Apps and Desktops (CVAD), also from Citrix Systems. Citrix Virtual Apps and Desktops is an application virtualization solution that enhances productivity with universal access to virtual sessions including virtual app, desktop, and data sessions from any device, plus the option to implement a scalable VDI solution. Virtual sessions may further include Software as a Service (SaaS) and Desktop as a Service (DaaS) sessions, for example.

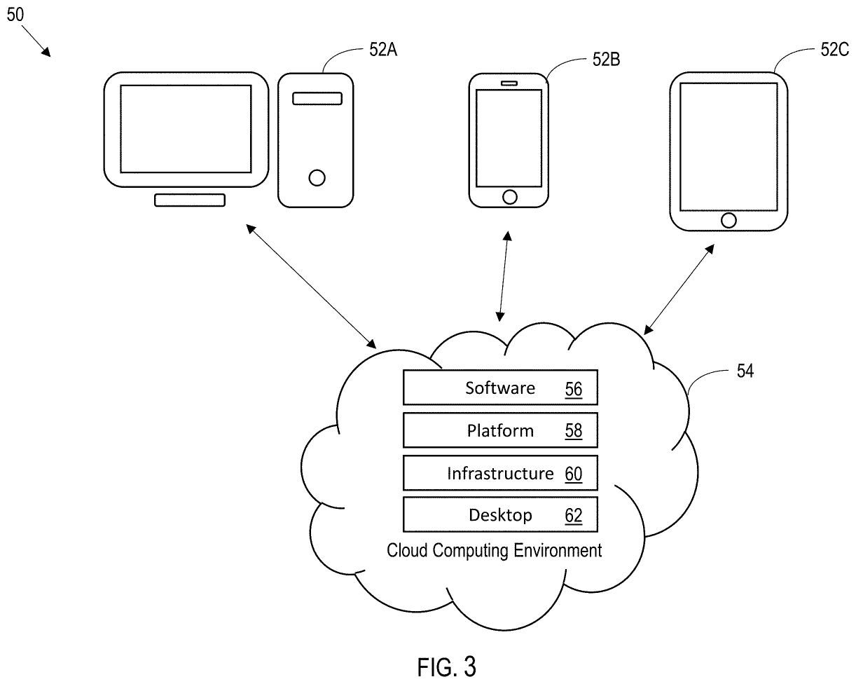

Referring to FIG. 3, a cloud computing environment 50 is depicted, which may also be referred to as a cloud environment, cloud computing or cloud network. The cloud computing environment 50 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 50, one or more clients 52A-52C (such as those described above) are in communication with a cloud network 54. The cloud network 54 may include backend platforms, e.g., servers, storage, server farms or data centers. The users or clients 52A-52C can correspond to a single organization/tenant or multiple organizations/tenants. More particularly, in one example implementation the cloud computing environment 50 may provide a private cloud serving a single organization (e.g., enterprise cloud). In another example, the cloud computing environment 50 may provide a community or public cloud serving multiple organizations/tenants. In still further embodiments, the cloud computing environment 50 may provide a hybrid cloud that is a combination of a public cloud and a private cloud. Public clouds may include public servers that are maintained by third parties to the clients 52A-52C or the enterprise/tenant. The servers may be located off-site in remote geographical locations or otherwise.

The cloud computing environment 50 can provide resource pooling to serve multiple users via clients 52A-52C through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 50 can provide on-demand self-service to unilaterally provision computing capabilities (e.g., server time, network storage) across a network for multiple clients 52A-52C. The cloud computing environment 50 can provide an elasticity to dynamically scale out or scale in responsive to different demands from one or more clients 52. In some embodiments, the computing environment 50 can include or provide monitoring services to monitor, control and/or generate reports corresponding to the provided shared services and resources.

In some embodiments, the cloud computing environment 50 may provide cloud-based delivery of different types of cloud computing services, such as Software as a service (SaaS) 56, Platform as a Service (PaaS) 58, Infrastructure as a Service (IaaS) 60, and Desktop as a Service (DaaS) 62, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Washington (herein “AWS”), for example. In the case of Citrix Cloud, Citrix Workspace app may be used as a single-entry point for bringing apps, files and desktops together (whether on-premises or in the cloud) to deliver a unified experience.

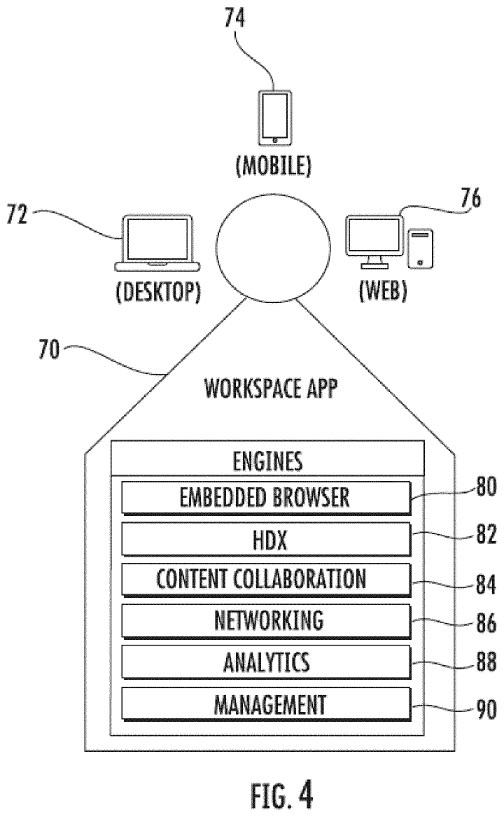

The unified experience provided by the Citrix Workspace app will now be discussed in greater detail with reference to FIG. 4. The Citrix Workspace app will be generally referred to herein as the workspace app 70. The workspace app 70 is how a user gets access to their workspace resources, one category of which is applications. These applications can be SaaS apps, web apps or virtual apps. The workspace app 70 also gives users access to their desktops, which may be a local desktop or a virtual desktop. Further, the workspace app 70 gives users access to their files and data, which may be stored in numerous repositories. The files and data may be hosted on Citrix ShareFile, hosted on an on-premises network file server, or hosted in some other cloud storage provider, such as Microsoft OneDrive or Google Drive Box, for example.

To provide a unified experience, all of the resources a user requires may be located and accessible from the workspace app 70. The workspace app 70 is provided in different versions. One version of the workspace app 70 is an installed application for desktops 72, which may be based on Windows, Mac or Linux platforms. A second version of the workspace app 70 is an installed application for mobile devices 74, which may be based on iOS or Android platforms. A third version of the workspace app 70 uses a hypertext markup language (HTML) browser to provide a user access to their workspace environment. The web version of the workspace app 70 is used when a user does not want to install the workspace app or does not have the rights to install the workspace app, such as when operating a public kiosk 76.

Each of these different versions of the workspace app 70 may advantageously provide the same user experience. This advantageously allows a user to move from client device 72 to client device 74 to client device 76 in different platforms and still receive the same user experience for their workspace. The client devices 72, 74 and 76 are referred to as endpoints.

As noted above, the workspace app 70 supports Windows, Mac, Linux, iOS, and Android platforms as well as platforms with an HTML browser (HTML5). The workspace app 70 incorporates multiple engines 80-90 allowing users access to numerous types of app and data resources. Each engine 80-90 optimizes the user experience for a particular resource. Each engine 80-90 also provides an organization or enterprise with insights into user activities and potential security threats.

An embedded browser engine 80 keeps SaaS and web apps contained within the workspace app 70 instead of launching them on a locally installed and unmanaged browser. With the embedded browser, the workspace app 70 is able to intercept user-selected hyperlinks in SaaS and web apps and request a risk analysis before approving, denying, or isolating access.

A high definition experience (HDX) engine 82 establishes connections to virtual browsers, virtual apps and desktop sessions running on either Windows or Linux operating systems. With the HDX engine 82, Windows and Linux resources run remotely, while the display remains local, on the endpoint. To provide the best possible user experience, the HDX engine 82 utilizes different virtual channels to adapt to changing network conditions and application requirements. To overcome high-latency or high-packet loss networks, the HDX engine 82 automatically implements optimized transport protocols and greater compression algorithms. Each algorithm is optimized for a certain type of display, such as video, images, or text. The HDX engine 82 identifies these types of resources in an application and applies the most appropriate algorithm to that section of the screen.

For many users, a workspace centers on data. A content collaboration engine 84 allows users to integrate all data into the workspace, whether that data lives on-premises or in the cloud. The content collaboration engine 84 allows administrators and users to create a set of connectors to corporate and user-specific data storage locations. This can include OneDrive, Dropbox, and on-premises network file shares, for example. Users can maintain files in multiple repositories and allow the workspace app 70 to consolidate them into a single, personalized library.

A networking engine 86 identifies whether or not an endpoint or an app on the endpoint requires network connectivity to a secured backend resource. The networking engine 86 can automatically establish a full VPN tunnel for the entire endpoint device, or it can create an app-specific μ-VPN connection. A μ-VPN defines what backend resources an application and an endpoint device can access, thus protecting the backend infrastructure. In many instances, certain user activities benefit from unique network-based optimizations. If the user requests a file copy, the workspace app 70 can automatically utilize multiple network connections simultaneously to complete the activity faster. If the user initiates a VoIP call, the workspace app 70 improves its quality by duplicating the call across multiple network connections. The networking engine 86 uses only the packets that arrive first.

An analytics engine 88 reports on the user's device, location and behavior, where cloud-based services identify any potential anomalies that might be the result of a stolen device, a hacked identity or a user who is preparing to leave the company. The information gathered by the analytics engine 88 protects company assets by automatically implementing counter-measures.

A management engine 90 keeps the workspace app 70 current. This not only provides users with the latest capabilities, but also includes extra security enhancements. The workspace app 70 includes an auto-update service that routinely checks and automatically deploys updates based on customizable policies.

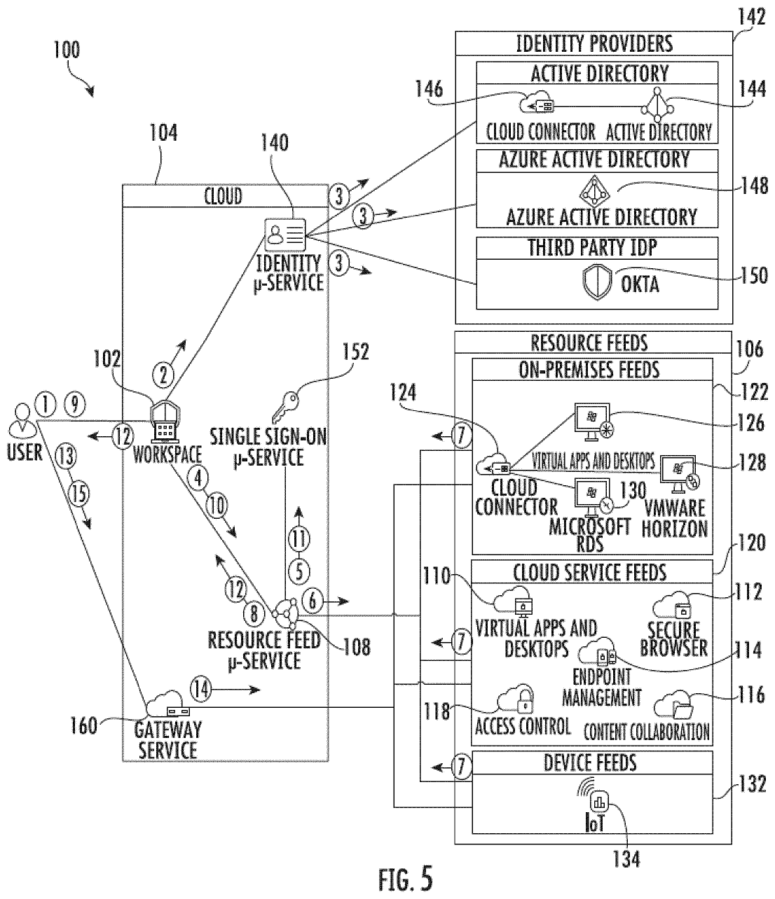

Referring now to FIG. 5, a workspace network environment 100 providing a unified experience to a user based on the workspace app 70 will be discussed. The desktop, mobile and web versions of the workspace app 70 all communicate with the workspace experience service 102 running within the Cloud 104. The workspace experience service 102 then pulls in all the different resource feeds 16 via a resource feed micro-service 108. That is, all the different resources from other services running in the Cloud 104 are pulled in by the resource feed micro-service 108. The different services may include a virtual apps and desktop service 110, a secure browser service 112, an endpoint management service 114, a content collaboration service 116, and an access control service 118. Any service that an organization or enterprise subscribes to are automatically pulled into the workspace experience service 102 and delivered to the user's workspace app 70.

In addition to cloud feeds 120, the resource feed micro-service 108 can pull in on-premises feeds 122. A cloud connector 124 is used to provide virtual apps and desktop deployments that are running in an on-premises data center. Desktop virtualization may be provided by Citrix virtual apps and desktops 126, Microsoft RDS 128 or VMware Horizon 130, for example. In addition to cloud feeds 120 and on-premises feeds 122, device feeds 132 from Internet of Thing (IoT) devices 134, for example, may be pulled in by the resource feed micro-service 108. Site aggregation is used to tie the different resources into the user's overall workspace experience.

The cloud feeds 120, on-premises feeds 122 and device feeds 132 each provides the user's workspace experience with a different and unique type of application. The workspace experience can support local apps, SaaS apps, virtual apps, and desktops browser apps, as well as storage apps. As the feeds continue to increase and expand, the workspace experience is able to include additional resources in the user's overall workspace. This means a user will be able to get to every single application that they need access to.

Still referring to the workspace network environment 20, a series of events will be described on how a unified experience is provided to a user. The unified experience starts with the user using the workspace app 70 to connect to the workspace experience service 102 running within the Cloud 104, and presenting their identity (event 1). The identity includes a username and password, for example.

The workspace experience service 102 forwards the user's identity to an identity micro-service 140 within the Cloud 104 (event 2). The identity micro-service 140 authenticates the user to the correct identity provider 142 (event 3) based on the organization's workspace configuration. Authentication may be based on an on-premises active directory 144 that requires the deployment of a cloud connector 146. Authentication may also be based on Azure Active Directory 148 or even a third party identity provider 150, such as Citrix ADC or Okta, for example.

Once authorized, the workspace experience service 102 requests a list of authorized resources (event 4) from the resource feed micro-service 108. For each configured resource feed 106, the resource feed micro-service 108 requests an identity token (event 5) from the single-sign micro-service 152.

The resource feed specific identity token is passed to each resource's point of authentication (event 6). On-premises resources 122 are contacted through the Cloud Connector 124. Each resource feed 106 replies with a list of resources authorized for the respective identity (event 7).

The resource feed micro-service 108 aggregates all items from the different resource feeds 106 and forwards (event 8) to the workspace experience service 102. The user selects a resource from the workspace experience service 102 (event 9).

The workspace experience service 102 forwards the request to the resource feed micro-service 108 (event 10). The resource feed micro-service 108 requests an identity token from the single sign-on micro-service 152 (event 11). The user's identity token is sent to the workspace experience service 102 (event 12) where a launch ticket is generated and sent to the user.

The user initiates a secure session to a gateway service 160 and presents the launch ticket (event 13). The gateway service 160 initiates a secure session to the appropriate resource feed 106 and presents the identity token to seamlessly authenticate the user (event 14). Once the session initializes, the user is able to utilize the resource (event 15). Having an entire workspace delivered through a single access point or application advantageously improves productivity and streamlines common workflows for the user.

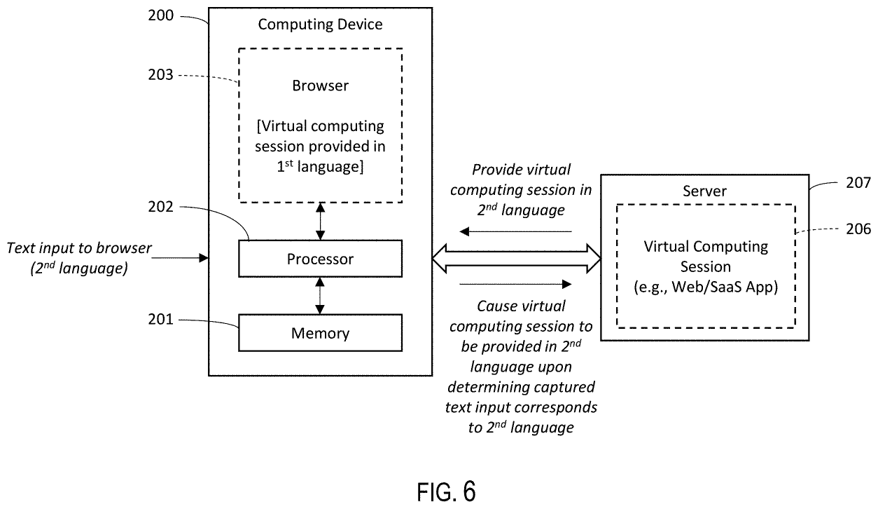

Turning now to FIG. 6, a computing device 200 provides for dynamic language detection and change for Web/SaaS apps based upon text input to the browser that is providing access to the Web/SaaS app session. The computing device 200 illustratively includes a memory 201 and a processor 202 coupled to the memory and configured to run a browser to access a virtual computing session 206, e.g., a Web/SaaS app session from a server 207. By way of example, the computing device 200 may take the form of a client computing device, such as a desktop computer, laptop computer, tablet computer, smartphone, etc. The processor 202 may take the form of a microprocessor and associated hardware, and the memory 201 may include non-transitory computer-readable instructions for causing the processor to perform the various operations discussed below. In some embodiments, the browser 203 may be a managed browser that is embedded at the computing device 200, or a hosted browser that is run remotely on a server, such as provided by Citrix Workspace and described further above. Generally speaking, a managed browsers provides an IT or virtual computing service provider enhanced abilities to set permission levels associated with the browser and/or access data input to the browser or received by the browser. However, a managed browser need not be used in all embodiments, and other approaches may be used to capture text input to standard browsers (e.g., Google Chrome, Microsoft Edge, etc.), as will be discussed further below.

By way of example, consider a German user who is working on a Windows 10 Desktop with the system locale set to de-DE (German, Germany). Yet, the Chrome browser installed on the personal computer (PC) is displayed with English by default. In this case, when the user launches the Web UI to access a Web/SaaS app (e.g., Citrix Workspace Web UI), the UI language will be set to English (en-US) consistent with the browser default setting. However, the user would otherwise expect a German UI, and it is typically not easy or intuitive for the user to manually change the preferred language through the browser, especially if the menu options to do so are not in the user's native language.

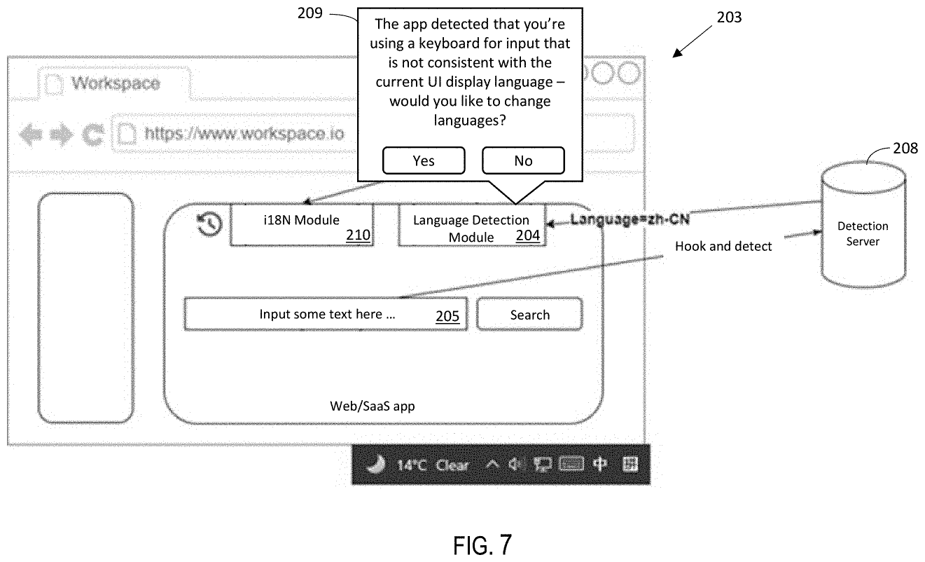

Tuning now to an example use case described further with reference to FIG. 7, a language detection module 204 may be integrated into a Web/SaaS platform (e.g., Workspace UI in this example). When a user starts to work on the Web/SaaS app and inputs text with a keyboard, such as in a form field 205 generated by the browser 203, the language module 204 will be activated. The language detection module 204 will first capture the text input to the form field 205 with APIs provided by the browser. If the input is in a letter-based language like English, German, Spanish, etc., key events will be handled to extract the letters or words. If the input is done with client Input Method Editor (IME) software, such as for Chinese/Japanese/Korean users, composition events can be used to capture the characters being input.

After receiving the input text, it is sent to a language detection server 208 for language detection. Various language detection services or tools may be used for the language detection, such as Lingua, for example. In some embodiments, the language detection may be performed locally, instead of by a remote service, as well. The detection results will be returned from the language detection server 208 with a target language code or locale (Language=zh-CN in the present example). Then, the language detection module 204 will query the target language in a supported language list of current Web apps, which may be stored in the memory 201 or by the server 207.

If the target language is supported and is not the same as the current (e.g., default) UI language, a pop-up window 209 is displayed in the present example which provides a message asking the user whether to switch to the target language (here, Chinese) for the current app. The user may accept or reject the switching operation as desired using the buttons provided in the pop-up window 209. However, in some embodiments, a pop-up window or prompt need not be used, and the language detection module may automatically trigger a change to the target language, if desired.

When the user confirms the switch to the target language, an i18n module 210 of the Web/SaaS app will update the current valid language. Moreover, the new language may be applied to the Web/SaaS app (e.g., SPA app) with the help of a frontend framework (e.g., React, Vue, etc.). In other instances, the Web/SaaS app may need to reload the page to fetch the new translated strings from the server 207, with the target language as a parameter. Once the new language has been chosen (or rejected) by the user, the language detection module 204 may suspend capturing text until needed again (e.g., upon the next start-up, etc.).

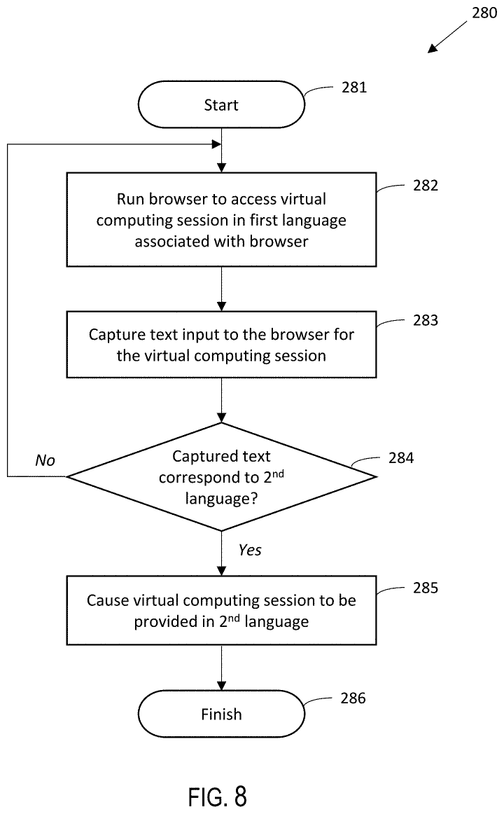

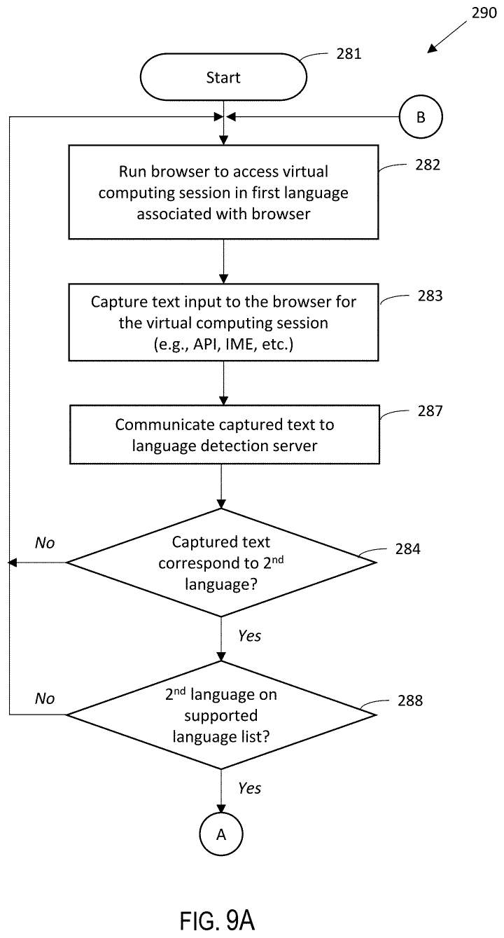

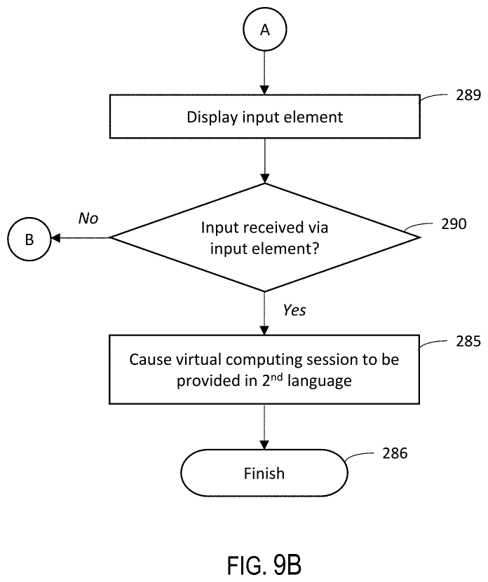

Turning now to the flow diagrams 280 and 290 of FIGS. 8, 9A and 9B, associated method aspects are now described. Beginning at Block 281, the computing device 200 runs a browser 203 to access the virtual computing session 206 (e.g., a Web or SaaS app), at Block 282. As noted above, the browser 203 will typically have a first (e.g., default) language associated therewith, and the virtual computing session 206 will be provided in the first language responsive to the browser. That is, the virtual computing session 206 may detect the default language of the browser 203 upon start-up, and provide the virtual computing session automatically in the detected language.

The method further illustratively includes capturing text input to the browser 203 at the computing device 200 for the virtual computing session 206, at Block 283, and determining whether the captured text corresponds to a second language different than the first language, at Block 284. As noted above, this may be done through an API of the browser, whether from key events or composition events (e.g., via an IME). The computing device 200 may accordingly cause the virtual computing session 206 to be provided in the second language at the computing device responsive to determining the captured text corresponds to the second language, at Block 285. The method of FIG. 8 illustratively concludes at Block 286.

As also noted above, in some embodiments the computing device 200 may communicate the captured text to a language detection server 208, and determine whether the captured text corresponds to the second language responsive to the language detection server (e.g., from a language code provided by the language detection server for the detected language). Moreover, in some implementations the computing device 200 may be further configured to determine if the second language is on a supported language list for the virtual computing session 206, at Block 288, and if so to cause the virtual computing session to be provided in the second language responsive thereto. That is, the computing device 200 may first check to see if the language the user is attempting to use is in fact one that is supported by the virtual computing session 206 before requesting that the server 207 change the virtual computing session over to the second language.

As also discussed above, in some embodiments the computing device 200 may display an input element (e.g., the pop-up window 209) responsive to determining the captured text corresponds to the second language, at Blocks 289-290. As a result, the computing device 200 may cause the virtual computing session 206 to be provided in the second language further based upon input received via the input element, such as through UI buttons that allow the user to change to the detected language, or keep the current (e.g., default) language.

The above-described approach advantageously allows for dynamic changing of the display language for virtual computing sessions (e.g., Web/SaaS apps) accessed through a browser automatically according to the input characters provided to the browser. This provides for relatively easy adaptation of Web/SaaS application to the preferred display language of the user, which usually will correspond to the language the user is attempting to use to provide input to the browser.

As will be appreciated by one of skill in the art upon reading the foregoing disclosure, various aspects described herein may be embodied as a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

Many modifications and other embodiments will come to the mind of one skilled in the art having the benefit of the teachings presented in the foregoing descriptions and the associated drawings. Therefore, it is understood that the foregoing is not to be limited to the example embodiments, and that modifications and other embodiments are intended to be included within the scope of the appended claims.

1. A computing device comprising:
a memory and a processor coupled to the memory and configured to
run a browser to access a virtual computing session, the browser having a first language associated therewith, and the virtual computing session being provided in the first language responsive to the browser,
capture text input to the browser for the virtual computing session,
determine whether the captured text corresponds to a second language different than the first language, and
cause the virtual computing session to be provided in the second language responsive to determining the captured text corresponds to the second language.

2. The computing device of claim 1 wherein the processor is further configured to determine if the second language is on a supported language list for the virtual computing session, and to cause the virtual computing session to be provided in the second language further based upon determining the second language is on the supported language list.

3. The computing device of claim 1 wherein the processor is further configured to cause the browser to display an input element responsive to determining the captured text corresponds to the second language, and to cause the virtual computing session to be provided in the second language further based upon input received via the input element.

4. The computing device of claim 1 wherein the browser has an Application Programming Interface (API) associated therewith, and wherein the processor is configured to capture the text input via the API.

5. The computing device of claim 1 wherein the processor is further configured to run an Input Method Editor (IME), and to capture the text input to the browser from the IME.

6. The computing device of claim 1 wherein the virtual computing session comprises at least one of a Web application and a Software as a Service (SaaS) application.

7. The computing device of claim 1 wherein the processor is further configured to communicate the captured text to a language detection server, and to determine whether the captured text corresponds to the second language responsive to the language detection server.

8. A method comprising:
running a browser at a computing device to access a virtual computing session, the browser having a first language associated therewith, and the virtual computing session being provided in the first language responsive to the browser;
capturing text input to the browser at the computing device for the virtual computing session;
determining, at the computing device, whether the captured text corresponds to a second language different than the first language; and
causing the virtual computing session to be provided in the second language at the computing device responsive to determining the captured text corresponds to the second language.

9. The method of claim 8 further comprising, at the computing device, determining if the second language is on a supported language list for the virtual computing session, and causing the virtual computing session to be provided in the second language further based upon determining the second language is on the supported language list.

10. The method of claim 8 further comprising, at the computing device, causing the browser to display an input element responsive to determining the captured text corresponds to the second language, and causing the virtual computing session to be provided in the second language further based upon input received via the input element.

11. The method of claim 8 wherein the browser has an Application Programming Interface (API) associated therewith, and wherein capturing the text input to the browser comprises capturing the text input to the browser via the API.

12. The method of claim 8 further comprising, at the computing device, running an Input Method Editor (IME), and wherein capturing the text input to the browser comprises capturing the text input to the browser from the IME.

13. The method of claim 8 wherein the virtual computing session comprises at least one of a Web application and a Software as a Service (SaaS) application.

14. The method of claim 8 further comprising, at the computing device, communicating the captured text to a language detection server; and wherein determining whether the captured text corresponds to the second language comprises determining whether the captured text corresponds to the second language responsive to the language detection server.

15. A non-transitory computer-readable medium having computer-executable instructions for causing a computing device to perform steps comprising:
running a browser to access a virtual computing session, the browser having a first language associated therewith, and the virtual computing session being provided in the first language responsive to the browser;
capturing text input to the browser for the virtual computing session;
determining whether the captured text corresponds to a second language different than the first language; and
causing the virtual computing session to be provided in the second language responsive to determining the captured text corresponds to the second language.

16. The non-transitory computer-readable medium of claim 15 further having computer-executable instructions for causing the computing device to perform steps comprising:
determining if the second language is on a supported language list for the virtual computing session; and
causing the virtual computing session to be provided in the second language further based upon determining the second language is on the supported language list.

17. The non-transitory computer-readable medium of claim 15 further having computer-executable instructions for causing the computing device to perform a step comprising causing the browser to display an input element responsive to determining the captured text corresponds to the second language; and wherein causing the virtual computing session to be provided in the second language is further based upon input received via the input element.

18. The non-transitory computer-readable medium of claim 15 wherein the browser has an Application Programming Interface (API) associated therewith, and wherein capturing the text input to the browser comprises capturing the text input to the browser via the API.

19. The non-transitory computer-readable medium of claim 15 further having computer-executable instructions for causing the computing device to perform a step comprising running an Input Method Editor (IME); and wherein capturing the text input to the browser comprises capturing the text input to the browser from the IME.

20. The non-transitory computer-readable medium of claim 15 further having computer-executable instructions for causing the computing device to perform a step comprising communicating the captured text to a language detection server; and wherein determining whether the captured text corresponds to the second language comprises determining whether the captured text corresponds to the second language responsive to the language detection server.
